(19) United States
(12) Patent Application Publication
(10) Pub. No.: US 2015/0019283 A1
(43) Pub. Date: Jan. 15, 2015

(54) SYSTEM FOR DEMAND LIMITING

(71) Applicant: Honeywell International Inc., Morristown, NJ (US)

(72) Inventor: Edward Koch, San Rafael, CA (US)

(21) Appl. No.: 14/481,452

(22) Filed: Sep. 9, 2014

Related U.S. Application Data
(63) Continuation-in-part of application No. 13/939,935, filed on Jul. 11, 2013.

(51) Int. Cl. G06Q 10/06

(52) U.S. Cl. CPC G06Q 10/06315
USPC 705/7.25

(57) ABSTRACT

A demand management system incorporating a demand response interface connectable to a utility/ISO, a demand dispatch subsystem connected to the demand response interface and connected to a facility that is an energy customer of the utility/ISO, and a demand level optimization subsystem connected to the demand dispatch subsystem. The demand dispatch subsystem may monitor the energy demand of the facility. The demand dispatch subsystem and the demand level optimization subsystem may predict how many demand limiting events are needed over a billing period of the energy customer and a cost of issuing the demand limiting events to set an energy demand limit to optimize a balance between a number of events and the costs of issuing the events needed to maintain the energy demand limit versus a benefit of keeping the energy demand of the facility within the energy demand limit.

The present application is a continuation-in-part of U.S. patent application Ser. No. 13/939,935, filed Jul. 11, 2013. U.S. patent application Ser. No. 13/939,935, filed Jul. 11, 2013, is hereby incorporated by reference.

### BACKGROUND

The present disclosure pertains to energy systems and particularly to demand response systems.

### SUMMARY

The disclosure reveals an energy demand limiting system that may, as an illustrative example, incorporate one or more facilities that are customers of a utility/ISO for energy, and an energy demand management subsystem connected to the utility/ISO and the one or more facilities. The energy demand management system may predict a number of demand limiting events and associated cost for issuing demand limiting events for a billing period of a facility, to set a specific demand limit. The energy demand management system may maintain a balance between a number of the demand limiting events with the associated cost for maintaining the specific demand limit, and a benefit of maintaining the specific demand limit for the facility. Application of the specific demand limit to energy use by the facility may reduce peak energy demand levels and thus reduce or eliminate demand charges for the billing period of the facility. The energy demand management system may monitor an energy demand of the facility and generate signals when the energy demand of the facility exceeds the specific demand limit. The signals may be sent to the facility. In response to the signals, an action such as a shed strategy may be executed to keep the energy demand of the facility from exceeding the specific demand limit.

### BRIEF DESCRIPTION OF THE DRAWING

FIG. 1 is a diagram of a basic demand response system;

FIG. 2 is a diagram of a demand response management system showing a demand response event;

FIG. 3 is a diagram of a customer demand management system;

FIG. 4 is a diagram of a more detailed breakdown of the customer demand management system and a customer facility; and

FIG. 5 is a diagram of a graph showing a typical daily demand for energy.

### DESCRIPTION

The present system and approach may incorporate one or more processors, computers, controllers, user interfaces, wireless and/or wire connections, and/or the like, in an implementation described and/or shown herein.

This description may provide one or more illustrative and specific examples or ways of implementing the present system and approach. There may be numerous other examples or ways of implementing the system and approach.

An effective resource is especially critical when communities are confronted with a scarcity of a resource in question. It may be noted that “resource” is a term that may have several senses or meanings. “Resource” may refer to energy, commodity, product, load, and so on. In another sense or meaning, “resource” such as a demand response (DR) resource may refer to a customer, a user, facility, and so on. In the first mentioned sense, it may refer to electricity, water, gas and natural resources such as oil. A definition of resource may be extended to include such things such as water quality and air quality. After all, adequate water quality and air quality appear necessary to support a self-sustaining environment.

Resource management, in both senses of “resource”, may be necessary so that systems can optimize the use of a limited resource. Currently, there are various systems for managing resources in various environments such as buildings, apartments, industrial facilities, and computing systems.

One mechanism that may be used to encourage customers to reduce demand and thereby reduce the peak demand for electricity may be referred to as demand response (DR). DR may refer to management of the demand by customers in response to supply conditions. For example, electricity customers may reduce their consumption at critical times and/or costs in response to market prices. These customers may be regarded as DR resources.

DR programs may require that a utility and/or independent service operator (ISO) deliver DR signals to participants via a communications channel. The programs may relate to a distribution of resources such as, but not limited to, electricity, water and natural gas.

DR signals may incorporate business level information, such as prices, reliability and shed levels. At some point, from the utility/ISO to loads in a facility, the business level information sent by the utility/ISO should be processed and used to execute a DR strategy and program for the facility.

DR programs may take many forms. They may differ from normal rates and tariffs in that the DR programs are designed to allow the utility/ISO take specific actions to influence the load profiles of facilities that participate in the DR programs at peak consumption times or periods on a grid. The peak consumption periods may cause critical grid reliability issues which should be addressed, but they may also trigger economic factors where the price of electricity or other power commodity reaches a critical level which may be ameliorated by reducing the overall consumption on the grid during those periods. The critical periods, in which the utility/ISO needs to influence a load profile of a facility, may be referred to as DR events.

A manner in which a utility/ISO may influence a load profile of a facility is to send out a DR signal which is specific to the DR event. DR signals may contain information related to business, controlling loads, and so on. There may be an automated DR where the DR signals that are sent out by the utility/ISO are responded to in an automated fashion. Loads within a facility may ultimately be affected by DR events via DR signals to which the facility acts upon or responds. The term “facility” may refer to virtually any location in which there are loads influenced by DR events. Where there are such loads may be regarded as a “DR resource”. The term “utility” may be used in a general sense to refer to a utility, independent system operator, service provider, and the like. It may be appropriate to use the term “demand side resource” in order to define a demand response resource.

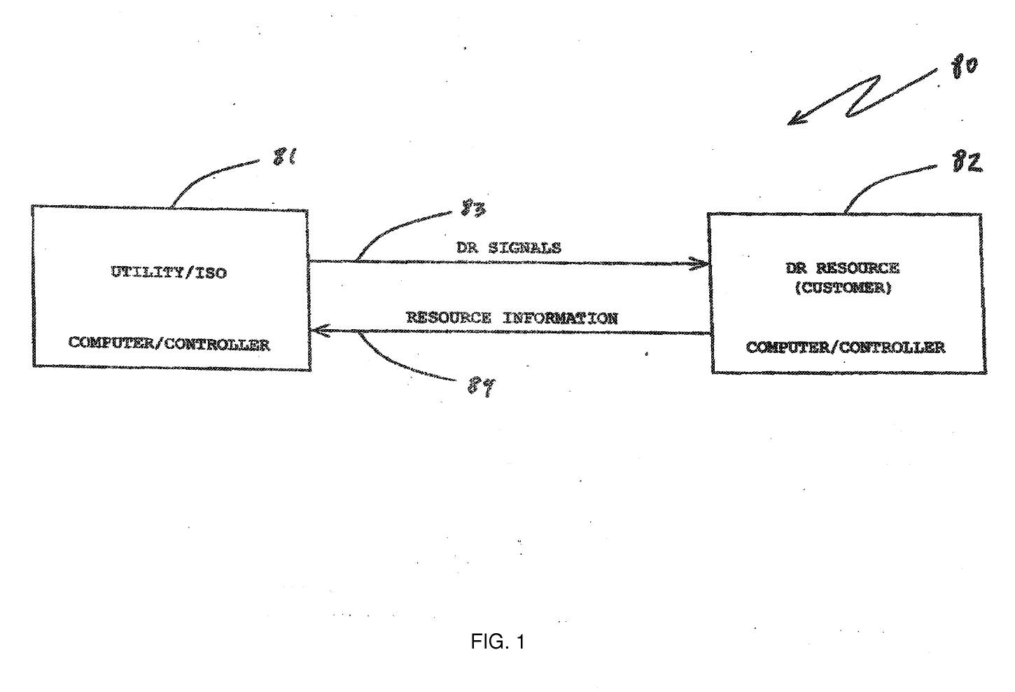

An implementation of DR signals within a “demand response management system” (DRMS) 80 is shown in a diagram of FIG. 1. System 80 and associated software may be effected and operated with one or more computers/controllers (controllers) 81, 82 and respective connections. The DRMS may be a system that is used by utilities/ISO's to manage the operation of DR programs. A focus of the DRMS may be on the operational aspects of managing the selection, signaling and monitoring of the DR resources that are participating in DR programs. The DRMS may be specifically designed to manage operations of automated DR programs.

There may be various types of interactions that could occur between the utility/ISO and a DR resource as part of a DR program. The diagram in FIG. 1 reveals an example interaction between a utility/ISO 81 and a DR resource (customer) 82. There may be DR signals 83 going from utility/ISO 81 to DR resource 82. There may be DR resource information 84, such as load measurements, going from DR resource 82 to utility/ISO 81.

Terms such as customer, client, user, participant, DR resource, and like terms, may be used, interchangeably or distinct from one another, depending on a context of a pertinent portion of a description or a claim.

A description of DR signals 83 may be noted. At a highest level, there may often be some sort of grid condition, be it economic or grid reliability in nature, which triggers a so-called DR event that requires some sort of interaction between the utility/ISO 81 and its customers 82. This interaction may eventually trigger some sort of load control taking place at a customer's facility. The interaction between the utility/ISO 81 and the customer 82 may be mediated by DR signals 83 and DR resource signals 84, i.e., information such as measurements. Signals 83 and 84 may represent communications between utility/ISO 81, and the DR resource or customer 82. Information contained within DR signals 83 may dictate where much of the decision-making takes place relative to, for example, in how the initial grid condition, which triggered the DR event, results in the eventual load control.

A computer or controller may incorporate one or more inputs, a processor, a user interface incorporating a keyboard, a display and a touch screen, a memory, external connections such as an internet, one or more outputs, and so forth. The computer may be utilized with virtually all items in and pertinent to FIGS. 1-5.

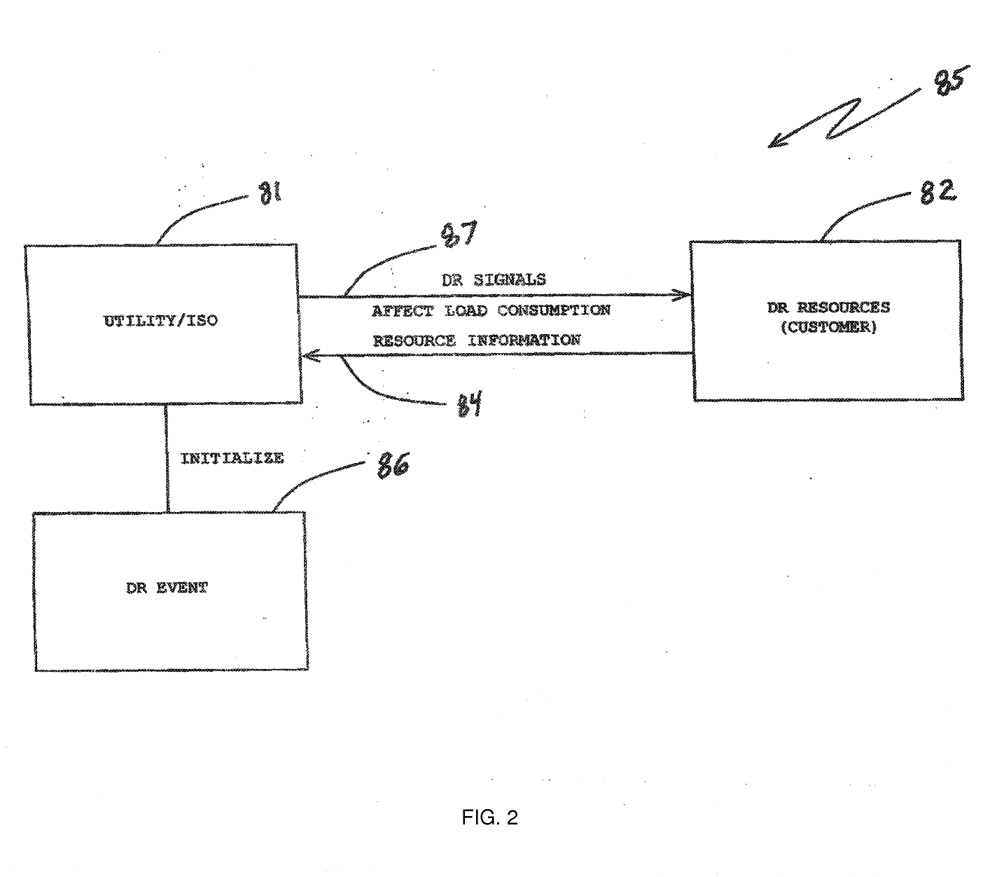

Automated demand response (ADR) programs may be used in a number of different customer market segments ranging from large commercial and industrial to small commercial and residential. A diagram of FIG. 2 shows a layout 85 of a utility/ISO 81 and DR resources 82. Utility/ISO 81 may enroll customers into demand response (DR) programs and model them as so called DR resources 82 that they can call upon when it is necessary for utility 81 to initiate a DR event 86. Calling upon a DR resource 82 typically means that the utility/ISO 81 “dispatches” the DR resources by sending them DR signals 87 which affect their load consumption in some predictable fashion. Information signals 84 may go from DR resources 82 to utility/ISO 81.

A pre-cursor to initiating a DR event 86 is the establishment of a set of objectives that need to be accomplished during the DR event. Such objectives may include the following items: 1) A specific amount of load response over some period of time (load responses may entail both reduced and increased levels of consumption); 2) Loads associated with a specific grid and/or geographic locations; 3) A specific type of loads; and 4) Loads with minimum response times and latencies.

When a utility 81 initiates a DR event 86, the utility may typically select some subset of the available DR resources 82 from the collection of all possible DR resources that meets the objectives as outlined above. Each DR resource 82 may have both capabilities and associated costs with using that resource during an event so the problem to be solved is how best to minimize the overall cost of a collection of DR resources while still using their capabilities to satisfy the overall objectives of the DR event 86. Furthermore, in the case of so called “Fast DR”, which may require dispatches to happen in real time, it may be necessary that the DR resource 82 selection process be automated and not require human operator involvement.

The use of so called intermittent renewable resources (IRR) may become more prevalent as a source of electricity generation. IRR may incorporate such resources as solar and wind generation. Other resources may be incorporated. By their very nature, the output of such generation of resources may be strongly dependent upon weather conditions.

When the output of the IRR's varies, it may be necessary to change the output of other one or more generators and/or the amount of electricity consumed by demand response resources in order to keep the electric grid balanced. Such balancing responsibilities may be performed either by a centralized balancing authority such as an independent system operator (ISO) or may be done locally near the IRR itself so that the net output of the IRR is less variable from the perspective of other entities on the grid.

Weather forecasts may play a key role in the planned usage of IRR's, but accurately predicting the weather appears very difficult and short term, and unexpected fluctuations may still occur. During such short term unexpected weather events, it may be necessary to quickly bring to bear resources that can be used to balance the changes in the IRR output. This may be done by metering the power generated by the IRR and responding accordingly when it fluctuates from expected values. The present approach may further improve upon that methodology by using demand response resources that respond to weather conditions before the output of the IRR is actually affected thus giving the other DR resources more time to respond to the inevitable fluctuations in the IRR caused by weather conditions.

The use of demand response resources for a purpose described herein may be referred to as demand response (DR) and the automated use of such resources could be regarded as an automated demand response (ADR). In the case of ADR, there may exist some entity that calls upon a DR resource by sending it a so-called DR signal that causes the DR resource to automatically change its load consumption by either consuming less or more electricity, depending upon the information that is in the DR signal.

When it is necessary to utilize a DR resource, this necessity may be typically referred to as a DR event. The solution described herein may link the initiation of DR events to real-time weather conditions. Unlike the use of longer term weather forecasts to predict and plan the use of various resources to balance fluctuations in IRR output, the present approach solution may use real time weather conditions to trigger DR events. Furthermore, the solution may link specific DR resources to specific IRR's and the weather conditions at the IRR.

The present solution may rely upon ADR resources. This reliance may mean that the control of load consumption at the DR resources is automated such that when a DR event is initiated, a DR signal is sent to the DR resource which results in an automated change in the DR resources load consumption. This may allow for a very fast response by the DR resources.

Furthermore, the DR resource may be programmed to both increase and decrease its load consumption depending upon the nature of the fluctuation at the IRR.

The benefits of such an approach may include the following items: 1) Better able to handle unexpected fluctuations in the IRR by responding before the output of the IRR changes; 2) Ability to couple DR resources with specific IRR's such that the balancing activities can be performed by the IRR owner instead of a more centralized balancing authority such as an ISO; 3) Can be used to offset both increased and decreased output from the IRR.

Some systems may do demand limiting including the use of a demand management system (DMS) which can trigger a need to reduce demand based upon some set of rules and analysis. Such systems may focus on approaches of load control or demand limiting strategies which can be employed to keep demand under some determined limit.

A focus of the present system may separate it from other systems is not necessarily the use of a DMS, but in how the DMS determines the critical demand limits that trigger events of demand limiting. While some systems may use fixed or perhaps operator determined limits, the present system may use a more sophisticated approach which is forward looking and incorporates the cost of issuing a demand limiting event. The system may operate in such a way to predict how many events will need to be called over the course of a billing period (i.e., a month) to set the demand limit thus striking a balance between the number of events (and the costs associated with those events) required to maintain a specific demand limit versus the benefit of keeping demand within that limit.

When customers are charged for electricity, the amount they must pay on a monthly basis may typically be determined by a number of factors. One of the primary factors may be a so called “demand charge” which is dependent upon the peak amount of power (i.e., demand in terms of kW) that the customer consumes at any point during the month. Typically, the demand charge may consist of some price per kW of demand. For example, if the peak demand at any time during the month is 100 kW and their demand rate is 1.50 per kW, the customer may be charged 100×1.5=$150 in demand charges. Thus, by reducing the peak demand levels during the course of a month may directly equate to reduced demand charges on the customer's monthly electricity bill.

One may note that this may be separate from another component of the customer's monthly bill which is the amount of energy consumed during the course of the month. This factor may be based upon the number of kWh that the customer consumes during the course of the month and which is different than the peak kW. Thus, it may be possible to reduce the peak demand and reduce the monthly demand charge while not lowering or possibly even increasing the amount of kWh consumed.

The present system may lower the peak demand of customers, thus lowering their demand charge on their monthly bills. The system may accomplish this by using a demand management system (DMS) that can monitor the customers' present demand in real time and generate signals that signify when a facility's demand is reaching critical levels and should be reduced. Such signals may be communicated to both facility automation equipment and to facility managers so that “shed strategies” can be executed which will curtail the facilities' demand and keep the demand under peak levels.

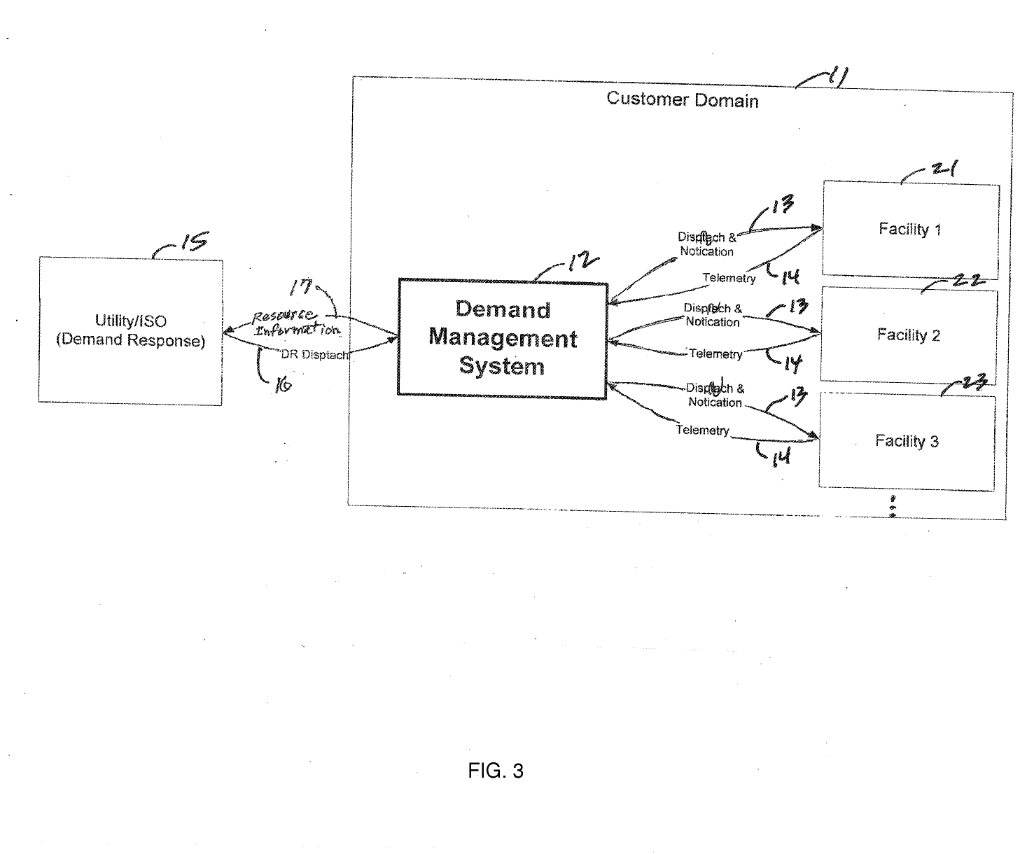

FIG. 3 is a diagram of a customer demand management system. A customer domain 11 may incorporate a demand management system (DMS)) 12 and one or more facilities, for example, a customer facility 21, facility 22, and facility 23. Communications may occur between DMS 12 and each facility. A dispatch and notification may go from DMS 12 to facility 21, 22 or 23. Telemetry 14 may go from facility 21, 22 or 23 to DMS 12. Outside of customer domain 11, a utility/ISO 15 may receive resource information 17/telemetry from DMS 12 of domain 11. Utility/ISO 15 may send a DR dispatch 16/DR signals to DMS 12 of domain 11.

The present system may be focused on DMS 12 that monitors the present demand and produces the signals for a customer facility and is not necessarily concerned with the specifics of how the loads within the customer facilities are controlled to reduce demand in response to the signals.

DMS 12 may be used to support multiple customer facilities 21, 22, 23, . . . , which can make demand limiting more cost effective since each facility does not necessarily need to have its own DMS.

The shed strategies and technologies used for load control to support demand limiting may be equally effective in supporting demand response (DR) with utilities and ISO's 15 and thus, DMS 12 may also be used as an intermediary for DR.

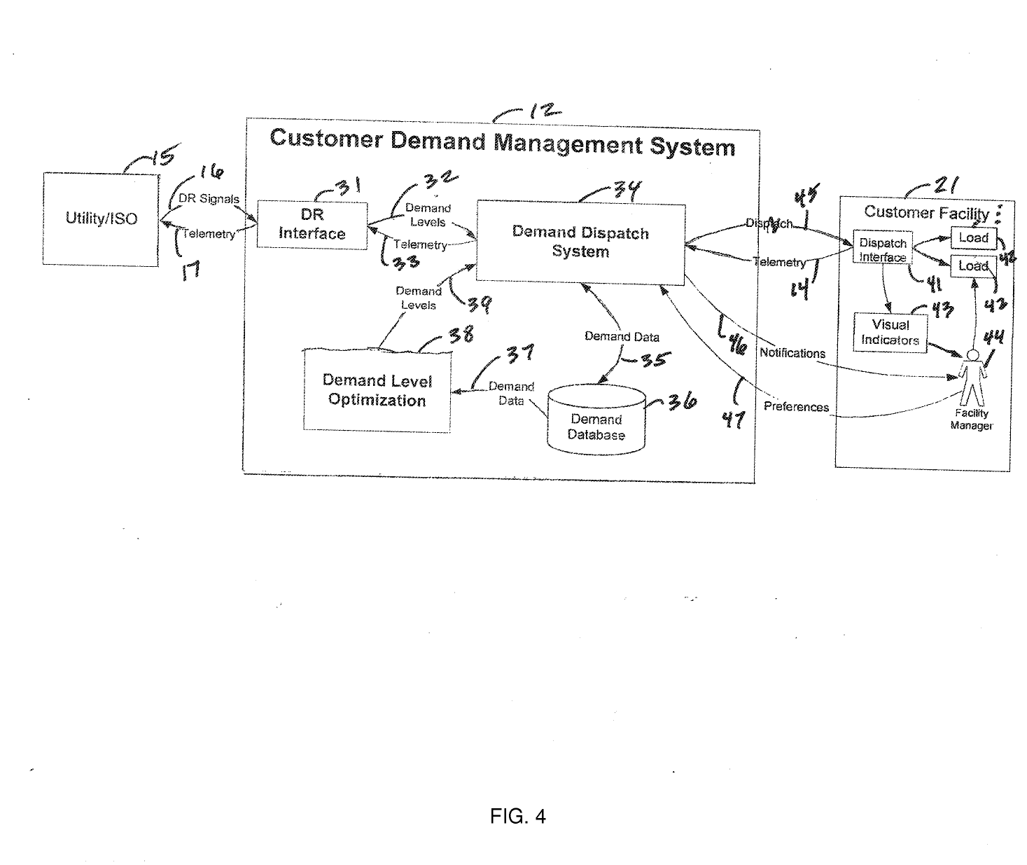

FIG. 4 is a diagram of further details of customer DMS 12 and, for example, customer facility 21. DR signals 16 may proceed from utility/ISO 15 to a DR interface 31 of DMS 12. Telemetry 17 may proceed from DR interface 31 to utility/ISO 15. Demand levels 32 may proceed from DR interface 31 to a demand dispatch system 34. Telemetry 33 may proceed from demand dispatch system 34 to DR interface 31. Demand data 35 may proceed from demand dispatch system 34 to a demand database 36. Also, demand data 35 may proceed from demand database 36 to demand dispatch system 34. Demand data 37 may proceed from demand database 36 to a demand level optimization mechanism 38. Demand levels 39 may proceed from demand level optimization mechanism 38 to demand dispatch system 34.

Customer facility 21 may have a dispatch interface 41 that can receive a dispatch 45 from demand dispatch system 34 of DMS 12 and send telemetry 14 to demand dispatch system 34. Dispatch interface 41 may control loads 42 in response to dispatch 45. A facility manager 44 may view visual indicators 43 of information to and from dispatch interface, such as dispatches 45 and telemetry 14, and notifications. With these inputs, facility manager 44 may provide some control of loads 42 and indicate preferences 47 to demand dispatch system 34.

Customer facility 21 may use electricity and have a particular demand profile. The profile may be a demand for the facility that is being optimized to reduce the demand charges on a customer's monthly bill. Customer facility 21 may contain a number of loads 42 that can be controlled in response to dispatch signals 45 received from DMS 12. How loads 42 may be controlled in response to receiving dispatch signals are particular to the type of facility and loads 42 within customer facility 21. The loads within the facility may be controlled in the following fashions.

First, loads 42 may be controlled automatically as a result of dispatch signals 45 being sent from the DMS 12 to facility dispatch interface 41. Dispatch interface 41 and a load 42 may each respectively have a processor or a controller. The dispatch signals 45 may be processed and propagated appropriately to loads 42 and their respective controllers such that the overall demand of customer facility 21 is reduced appropriately. Such actions by the load controllers may range from adjusting individual load operations to shutting down entire parts of customer facility 21. The nature of dispatch signals 45 sent by DMS 12 may be dependent upon the sophistication of the automation system within the facility. In some cases, dispatch signals 45 may be specific demand levels (e.g., 100 kW) that need to be achieved. In other cases, dispatch signals 45 may be simple discrete levels (e.g., normal, moderate and high) so that the automation system may simply execute pre-programmed shed strategies that correspond to each of the levels. The nature and form of the dispatch signals may be configured by a facility manager 44 as described herein relative to DMS 12.

Second, loads 42 may be manually controlled as a result of notifications 46 sent by DMS 12 directly to facility managers 44. Notifications 46 may be in the form of emails, texts, phone calls, and so on. Notifications 46 may contain demand objectives that are either explicit or perhaps implied by simple discrete levels. Upon receiving notifications 46, facility manager 44 may manually take appropriate actions of the one or more loads to meet the objectives in notifications 46. The actions may range from adjusting controls to shutting down entire parts of the operation of customer facility 21.

Facility loads 42 may be controlled semi-automatically where dispatches 45 received from DMS 12 are displayed in some fashion, such as visual indicators 43, within facility 21 so that occupants of the facility become aware of the demand state and act appropriately to modify their behavior or take some specific action. Displays of information may be textual or as simple as a set of colored lights (e.g., green, yellow and red) that indicate the extent to which the occupants should be trying to shed load within their area of responsibility.

In addition to handling dispatches 45 from DMS 12, dispatch interface 41 within facility 21 may also be responsible for sending telemetry 14 in the form of real-time demand data to DMS 12. DMS 12 may use the data to determine what dispatches 45 may need to be sent to facility 21.

Demand management system (DMS) 12 may be further described herein. A demand dispatch system (DDS) 34 may be responsible for interfacing with a customer facility 21 to perform items such as sending dispatch signals 45 to customer facility 21, sending notifications 46 to facility managers 44, and receiving and storing in a database 36, real-time demand data (telemetry) 14 from customer facility 21.

In order to determine what dispatches 45 should be sent to the facility, DDS 34 may compare the real-time demand telemetry 14 from facility 21 with the demand level objectives that DDS 34 received from either DR interface 31 or demand level optimizer or demand level optimization subsystem 38.

How each of the subsystems determines demand levels may be noted. An objective of DMS 12 may be to insure that the present demand level of customer facility 21 does not necessarily exceed the demand level objectives. DMS 12 may do this by sending the demand level objectives to customer facility 21 as described herein.

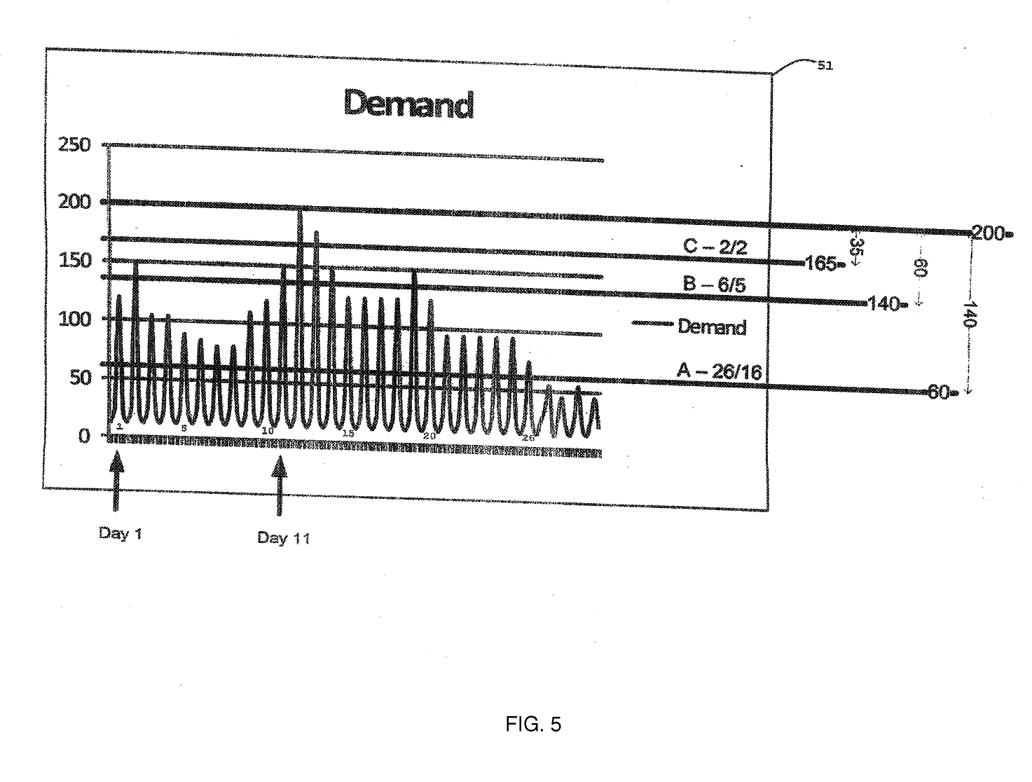

FIG. 5 is a diagram of a graph 51 of a typical daily demand for energy. The graph reveals a scale of 0 to 250 units in magnitude versus a time scale of days. A period of 26 days of peaks exceeding a magnitude of 60 units may be noted. Sixteen days have peaks exceeding 100 units. Two days may be noted with peaks exceeding 165 units. Six days may have peaks exceeding 140 units. Differences between the various marked levels of magnitude, such as 35, 60 and 140, are shown at the right side of graph 51.

To recap, a demand management system may incorporate a demand response interface connectable to a utility/ISO, a demand dispatch subsystem connected to the demand response interface and connected to one or more facilities that are energy customers of the utility/ISO, and a demand level optimization subsystem connected to the demand dispatch subsystem.

The demand dispatch subsystem may monitor the energy demand of a facility. The demand dispatch subsystem and the demand level optimization subsystem may predict how many demand limiting events are needed over a billing period of the energy customer and a cost of issuing the demand limiting events to set an energy demand limit to optimize a balance between a number of events and the costs of issuing the events needed to maintain the energy demand limit versus a benefit of keeping the energy demand of the facility within the energy demand limit.

If the energy demand limit is exceeded by energy usage of the facility, the facility may receive demand charges for the billing period.

The demand dispatch system may monitor the energy demand in real time of the facility. If the energy demand of the facility approaches or exceeds the energy demand limit, the demand dispatch system may send signals to the facility indicating that the energy demand of the facility should be reduced. The signals may go to the dispatch interface or a manager of the facility for automatic or manual reduction, respectively, of the energy demand to a level below the energy demand limit. A reduction of the energy demand level may be effected with an execution of a shed strategy.

An energy demand limiting mechanism may incorporate a utility/ISO, one or more facilities that are customers of the utility/ISO for energy, and an energy demand management system connected to the utility/ISO and the one or more facilities. The energy demand management system may predict a number of demand limiting events and associated cost for issuing demand limiting events for a billing period of a facility, to set a specific demand limit. The energy demand management system may maintain a balance between a number of the demand limiting events with the associated cost for maintaining the specific demand limit, and a benefit of maintaining the specific demand limit for the facility.

Application of the specific demand limit to energy use by the facility may reduce peak energy demand levels and thus reduce or eliminate demand charges for the billing period of the facility.

The energy demand management system may monitor an energy demand of the facility in real-time. The energy demand management system may generate signals when the energy demand of the facility exceeds the specific demand limit. The signals may be sent to the facility. In response to the signals, a shed strategy may be executed to keep the energy demand of the facility from exceeding the specific demand limit.

An arrangement for demand limiting may incorporate a customer demand management system, and one or more customer facilities. Each of the one or more customer facilities may incorporate a dispatch interface connected to the customer demand management system, and one or more loads connected to the dispatch interface. The customer demand management system may monitor present demand and produce signals for the one or more customer facilities. The one or more customer facilities may reduce demand in response to the signals. Each facility of the one or more customer facilities may have a demand profile that is optimized to reduce demand charges on a bill for energy use by the facility.

The customer demand management system may incorporate a DR interface, a demand dispatch sub-system connectable to the one or more customer facilities, and a demand level optimizer.

The DR interface may be connectable to a utility/ISO.

The customer demand management system may further incorporate a demand database connected to the demand dispatch subsystem and the demand level optimizer.

The one or more loads may be controlled in response to dispatch signals from the customer demand management system via the dispatch interface. The dispatch signals may be formed for a particular type of dispatch interface and the one or more loads.

The dispatch interface may incorporate a processor. Each of the one or more loads may incorporate a controller connected to the processor of the dispatch interface. The dispatch signals from the demand dispatch subsystem may go to the processor of the dispatch interface for processing and may be propagated to the controller of each load of the one or more loads. The controller may adjust operations of each load for achieving a demand level.

The demand level may be indicated by a specific number of energy units.

The demand level may be indicated by a category from a selection of categories.

Each demand level may result in an automatic execution of a pre-programmed shed strategy that corresponds to the respective demand level.

The demand dispatch subsystem may provide a notification to a manager or managers of the one or more customer facilities. The notification may contain demand objectives. In response to the notification, the manager or managers may manually adjust the one or more loads of their respective facilities, to meet the demand objectives of the notification.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A demand management system comprising:
a demand response interface connectable to a utility/ISO;
a demand dispatch subsystem connected to the demand response interface and connected to one or more facilities that are energy customers of the utility/ISO; and
a demand level optimization subsystem connected to the demand dispatch subsystem; and
wherein:
the demand dispatch subsystem monitors the energy demand of a facility; and
the demand dispatch subsystem and the demand level optimization subsystem predict how many demand limiting events are needed over a billing period of the energy customer and a cost of issuing the demand limiting events to set an energy demand limit to optimize a balance between a number of events and the costs of issuing the events needed to maintain the energy demand limit versus a benefit of keeping the energy demand of the facility within the energy demand limit.

2. The system of claim 1, wherein if the energy demand limit is exceeded by energy usage of the facility, the facility receives demand charges for the billing period.

3. The system of claim 1, wherein:
the demand dispatch system monitors the energy demand in real time of the facility; and
if the energy demand of the facility approaches or exceeds the energy demand limit, the demand dispatch system sends signals to the facility indicating that the energy demand of the facility should be reduced.

4. The system of claim 3, wherein the signals go to the dispatch interface or a manager of the facility for automatic or manual reduction, respectively, of the energy demand to a level below the energy demand limit.

5. The system of claim 4, wherein a reduction of the energy demand level is effected with an execution of a shed strategy.

6. An energy demand limiting mechanism comprising:
a utility/ISO;
one or more facilities that are customers of the utility/ISO for energy; and
an energy demand management system connected to the utility/ISO and the one or more facilities; and
wherein:
the energy demand management system predicts a number of demand limiting events and associated cost for issuing demand limiting events for a billing period of a facility, to set a specific demand limit;
the energy demand management system maintains a balance between a number of the demand limiting events with the associated cost for maintaining the specific demand limit, and a benefit of maintaining the specific demand limit for the facility.

7. The mechanism of claim 6, wherein application of the specific demand limit to energy use by the facility reduces peak energy demand levels and thus reduces or eliminates demand charges for the billing period of the facility.

8. The mechanism of claim 7, wherein:
the energy demand management system monitors an energy demand of the facility in real-time; and
the energy demand management system generates signals when the energy demand of the facility exceeds the specific demand limit.

9. The mechanism of claim 8, wherein:
the signals are sent to the facility; and
in response to the signals, a shed strategy is executed to keep the energy demand of the facility from exceeding the specific demand limit.

10. An arrangement for demand limiting comprising:
a customer demand management system; and
one or more customer facilities; and
wherein:
each of the one or more customer facilities comprises:
a dispatch interface connected to the customer demand management system; and
one or more loads connected to the dispatch interface;
the customer demand management system monitors present demand and produces signals for the one or more customer facilities;
the one or more customer facilities reduce demand in response to the signals; and
each facility of the one or more customer facilities has a demand profile that is optimized to reduce demand charges on a bill for energy use by the facility.

11. The arrangement of claim 10, wherein the customer demand management system comprises:
a DR interface;
a demand dispatch sub-system connectable to the one or more customer facilities; and
a demand level optimizer.

12. The arrangement of claim 11, wherein the DR interface is connectable to a utility/ISO.

13. The arrangement of claim 11, wherein the customer demand management system further comprises a demand database connected to the demand dispatch subsystem and the demand level optimizer.

14. The arrangement of claim 11, wherein:
the one or more loads are controlled in response to dispatch signals from the customer demand management system via the dispatch interface; and
the dispatch signals are formed for a particular type of dispatch interface and the one or more loads.

15. The arrangement of claim 14, wherein:
the dispatch interface comprises a processor; and
each of the one or more loads comprises a controller connected to the processor of the dispatch interface.

16. The arrangement of claim 15, wherein the dispatch signals from the demand dispatch subsystem go to the processor of the dispatch interface for processing and are propagated to the controller of each load of the one or more loads.

17. The arrangement of claim 16, wherein the controller can adjust operations of each load for achieving a demand level.

18. The arraignment of claim 17, wherein the demand level can be indicated by a specific number of energy units.

19. The arrangement of claim 17, wherein the demand level can be indicated by a category from a selection of categories.

20. The arrangement of claim 17, wherein each demand level can result in an automatic execution of a pre-programmed shed strategy that corresponds to the respective demand level.

21. The arrangement of claim 11, wherein:
the demand dispatch subsystem can provide a notification to a manager or managers of the one or more customer facilities;
the notification contains demand objectives; and
in response to the notification, the manager or managers can manually adjust the one or more loads of their respective facilities, to meet the demand objectives of the notification.
